(19) United States
(12) Patent Application Publication
(10) Pub. No.: US 2022/0049450 A1
(43) Pub. Date: Feb. 17, 2022

(54) Shear Resistant Geomembrane Using Mechanical Engagement

(71) Applicant: Watershed Holdings LLC, Alpharetta, GA (US)

(72) Inventors: William Delaney Lewis, West Monroe, LA (US); Zehong Yuan, Norcross, GA (US); Jose L. Urrutia, Suwanee, GA (US)

(73) Assignee: Watershed Holdings LLC, Alpharetta, GA (US)

(21) Appl. No.: 17/403,421

(22) Filed: Aug. 16, 2021

Related U.S. Application Data
(60) Provisional application No. 63/066,155, filed on Aug. 14, 2020.

(51) Int. Cl. E02D 17/20

(52) U.S. Cl. CPC E02D 17/202; E01C 13/08; E02D 2300/0087

(57) ABSTRACT

An elongated polymeric impermeable geomembrane sheet having opposing first and second surfaces with a plurality of spaced-apart first projections extending from the first surface, said first projections each tapering to a pointed apex at a distal extent, which first projections for mechanically engaging a synthetic drainage geomesh sheet overlaid by a tufted geotextile sheet and in contact with adjacent fill materials within the aggregation, whereby the aggregation has increased resistance to shear failure of the aggregation of fill materials and reducing stabilization failures of materials aggregation applications. A ground covering closure system is disclosed.

### TECHNICAL FIELD

The present invention relates to geomembranes having high shear resistance for use in stabilizing piles or mounds of deposited aggregations of materials. More particularly, the present invention relates to shear resistant geomembranes that mechanically engage to overlying fabric liners for use in stabilizing layered deposit aggregations in layers, piles, or built-up mounds of granular particulate and solids materials, which layers are susceptible to plane shear failure arising from lack of force loading on the aggregation or shear load applied on the geomembranes, especially on sloped surfaces.

In this application, the following terms will be understood to have the indicated definitions:

waste sites—refers to earthen berms and to sites where waste is deposited, such as landfills, phosphogypsum stacks, environmentally impacted land, leach pads, mining spoils and environmental closures or material stockpiles that require a closure or cover system;

synthetic grass—refers to a composite of at least one geotextile (woven or nonwoven) tufted or knitted with one or more synthetic yarns or strands that has the appearance of grass;

geomembrane—refers to a structured or textured polymeric material, such as high-density polyethylene, very low-density polyethylene, linear low-density polyethylene, polyvinyl chloride, provided as an impermeable sheet for liner purposes in the waste site and land site industry.

### BACKGROUND OF THE INVENTION

Large area aggregations of particulate and solids materials collected together as a mass of distinct parts are found in a wide range of structural applications. These applications include landfill and waste storage sites, manufacturing products storage laydown areas and by-product waste storage and holding fields, stockpiles, power plant disposal fields, reinforced foundations for roadways, retaining wall structures, and the like. Such applications typically involve the depositing of particulate and solids materials often in sloped landsite collections or aggregations but may be substantially planar layers of such materials as well. For example, landfills and waste sites typically form sloped collections of the particulate and solids materials deposited in layers, piles, and mounds for long term storage and containment. Planar structures such as for roadways and backfill for retaining wall structures typically have stacked layers of particulate and solids materials, which layers may be of differing materials characteristics such as materials or particulate type, grade, and layer dimensions.

Each of such aggregations are susceptible to planar failures arising from shear loading. Planar failure may cause catastrophic slope failure and avalanche conditions in which the material within the aggregation suddenly releases and moves under loading. The loading may arise from the mass of the materials in the aggregation becoming released from engagement or external forces, particularly, for example, hydraulic shear forces arising from water flow across the aggregation or across a covering closure system, such as caused by rain storms or by vertical acceleration and deceleration forces, or combinations of such internal and external loading forces.

Landfills and waste sites, for example, typically remain open for a number of years for receiving waste materials, mining spoils or power plant wastes and ash, landfill trash and municipal solids and liquids wastes. Such waste sites typically have steep slopes rising from a toe or base to an upper elevated apex or peak as the additional deposits of waste materials are made over time. The elevation may typically reach several hundred feet above the toe with deposits over time of fill materials. While steep slopes allow geometrically increased storage volume, steep slopes experience significantly high shear forces. These forces occur in response to the fill materials loaded in within a vertical portion of the area allocated for the landfill and also arise from precipitation and water flow such as from rain fall on the waste site that generates high volumes of water flowing downwardly to the toe. Steep slopes often experience large and rapid run-off. Upon reaching an appropriate capacity for the particular site, the site is closed to receiving additional waste materials. Closure involves overlaying a water impermeable ground cover such as a geomembrane and a synthetic drainage system over the aggregation land site. The ground cover restricts water inflow into the collected particulate and solids materials to prevent contamination of below-grade water tables while the synthetic drainage system provides for water flow off of the cover system. Ground cover design and installation needs to consider cover stability for the long-term post-closure covering of the site.

Closure systems for landfills use geomembranes and synthetic drainage systems covered by soil (typically 18 inches to 24 inches) for developing a final grass growth on the upper soil surface. The weight or mass of the soil develops friction to resist shear loading and site slope failures. The synthetic drainage is composite layered sheet having a core geonet mesh sheet with spaced-openings and sandwiched by a fabric overlay that restricts soil from filing the openings and a fabric underlay that sits on the upper surface of the aggregation site to be closed. Ambient and environmental water such as from rain or snow percolates through the soil and flows off the covered site by the synthetic drainage system. However, in recent years, landfills have been covered with lightweight (lighter than the soil mass) geosynthetics such as synthetic grass of tufted fabric backing. While there are benefits to synthetic grass ground covers, the weight of such covers is insufficient for developing friction to avoid sliding on steep slopes (for example, up to 1:1 gradients) in high shear loading that occurs particularly during rail storms. Also, planar applications such as road ways and retaining wall backfill aggregations include stacked layers of granular materials, particulates, and soil materials. These structures provide foundations for roadway and secure retaining walls.

To increase resistance to shear loading and thus resistance to slope failure, installations typically include spaced geomembrane sheets between adjacent layers of fill materials. The interposed geomembrane provides a frictional engagement with the adjacent layers of fill materials, whereby the aggregation becomes interlinked and stabilized against planar failure.

While geomembranes providing frictional resistance to planar failure and increased aggregation stability, there are drawbacks. The frictional resistance may be insufficient to retain the fill materials under loading, typically extreme loading, such as from heavy rainfall events and flooding that in combination with internal loading creates high shear forces on the aggregation. For example, light weight synthetic grass or tufted geosynthetic sheets overlaid on steep sloped ground surfaces lack sufficient mass or weight to develop frictional surface-to-surface engagement that resists the shear forces causing sloped aggregation failure and movement.

Accordingly, there is a need in the art for an improved geomembrane having increased shear resistance for use in covering closure of materials aggregation applications using confining pressures that otherwise surface exposed layered materials cannot achieve. It is to such that the present invention is directed.

### SUMMARY OF THE INVENTION

The present invention meets the need in the art by providing an improved geomembrane for use in resisting shear loading in materials aggregation applications and in reducing stabilization failures of materials aggregation applications. The improved geomembrane comprises an elongated polymeric impermeable sheet having opposing surfaces with a plurality of spaced-apart first projections extending from a first surface, which first projections mechanically engage, puncture, or pierce a respective geotextile sheet with the geomembrane in contact with adjacent fill materials within the aggregation, whereby the aggregation has increased resistant to shear failure of the aggregation of fill materials.

In another aspect, the present invention meets the need in the art by providing a ground cover system for a covering closure of a land site, comprising an elongated polymeric impermeable sheet having opposing first and second surfaces, for overlying a ground surface to be closed, with a plurality of spaced-apart first projections extending from the first surface. The first projections each tapering to a pointed apex at a distal extent. A covering for overlying the first surface of the elongated polymeric impermeable sheet, which first projections for mechanically engaging, puncturing, or piercing the covering. Upon covering installation, the aggregation has increased resistance to shear failure of the aggregation of fill materials for reducing stabilization failures of materials in aggregation land sites.

In another aspect, the present invention provides an aggregation cover system for a covering closure, comprising a liner sheet having opposing first and second surfaces, for overlying an aggregation surface to be closed and a plurality of spaced-apart spikes extending from the first surface, each said first projections tapering to a respective pointed apex at a distal extent. A tufted geosynthetic of a backing sheet tufted with yarns to define a plurality of spaced-apart tufts of synthetic grass blades extending from the backing sheet as a covering for overlying the first surface of the liner sheet, whereby said spikes for mechanically engaging the backing sheet to resist movement of the tufted geosynthetic during shear loading while the tufted geosynthetic frictionally engages the aggregation surface. The aggregation has increased resistance to shear failure of the aggregation of fill materials for reducing stabilization failures of materials in aggregation land sites.

In the geomembrane as recited above, the first projections are spaced apart to have a first density.

In the geomembrane as recited above, an alternate embodiment further comprises a plurality of spaced-apart second projections extending from a second opposing surface.

In the geomembrane as recited above, in which the second projections are spaced apart to have a second density.

The geomembrane as recited above, wherein the first projections and the second projections extend from the respective surface to an extent from about 10 mills to about 100 mills relative to the respective surface, and preferably the extent is about 40 mils.

The geomembrane as recited above, wherein the first projections are spikes, spines, or pointed pins, knobs, posts, extending members, or projections with distal pointed tips, angled tipped members, for mechanical puncture or piercing engagement with an adjacent overlying sheet material.

The geomembrane as recited above, wherein the second projections are spikes, spines, or pointed pins, knobs, posts, extending members, or projections with distal pointed tips, angled tipped members, for further mechanical puncture or piercing engagement with exposed surface layer of the collected particulate and solids materials.

The geomembrane as recited above, wherein an extent of the respective first projections is of a first length and the extent of the respective second projections is of a second length, the first length different from the second length.

The geomembrane as recited above, wherein at least the first projections have an axis oriented on a perpendicular relative to the surface of the geomembrane.

The geomembrane as recited above, wherein at least the first projections have an axis oriented at an oblique angle relative to a perpendicular to the surface.

The geomembrane as recited above, wherein the oblique angle of the axis of the first projections is from about 1 degree to about 45 degrees, preferably from about 5 degrees to about 20 degrees, and more preferably from about 10 degrees to about 15 degrees.

The geomembrane as recited above, wherein the geomembrane has an interface shear strength to resist shear load.

Objects, advantages, and features of the improved geomembrane and cover system will become apparent upon a reading of the detailed description in conjunction with the drawings illustrating various embodiments of the improved geomembrane.

### BRIEF DESCRIPTION OF THE DRAWINGS

FIG. 1A illustrates in perspective view a first embodiment of a geomembrane in accordance with the present invention.

FIG. 1B illustrates in perspective view a second embodiment of a geomembrane in accordance with the present invention.

FIG. 1C illustrates in perspective view a third embodiment of a geomembrane in accordance with the present invention.

FIG. 2 illustrates in cross-sectional view the geomembrane illustrated in FIG. 1A.

FIG. 3 illustrates in detailed cross-sectional view the geomembrane illustrated in FIG. 1B.

FIG. 4 illustrates in schematic view a manufacturing effect to define a gripping apex for the spikes formed for use with the geomembrane illustrated in FIGS. 1A-1C.

FIG. 5 illustrates in perspective view an alternate embodiment of the geomembrane illustrated in FIG. 1A with a textured surface.

FIG. 6 illustrates in exploded cross-sectional view an aggregation application using the geomembrane in mechanical engagement with a fabric overlay for aggregation stabilization and resisting shear force failure, in accordance with the present invention.

FIG. 7 illustrates in cross-sectional view a sloped surface of an aggregation application on a land site using a synthetic drainage assembly overlaid by a mass material soil for holding frictional engagement between the synthetic drainage assembly and the overlaid surface.

FIG. 7A illustrates in perspective view a detailed portion of the synthetic drainage assembly having a geocomposite textile/geonet mesh/textile structure.

FIG. 8 illustrates in exploded cross-sectional view an aggregation application using the geomembrane of the present invention in mechanical and frictional engagement with an improved synthetic drainage of a geonet mesh for aggregation stabilization and resisting shear force failure, in accordance with the present invention.

FIG. 9 illustrates in exploded cross-sectional view an aggregation application using the geomembrane of the present invention in mechanical and frictional engagement with a lightweight tufted geosynthetic for aggregation stabilization and resisting shear force failure, in accordance with the present invention.

FIG. 10 illustrates in exploded cross-sectional view an aggregation application using the geomembrane of the present invention in mechanical and frictional engagement with a lightweight tufted geosynthetic for aggregation stabilization and resisting shear force failure, in accordance with the present invention.

### DETAILED DISCUSSION

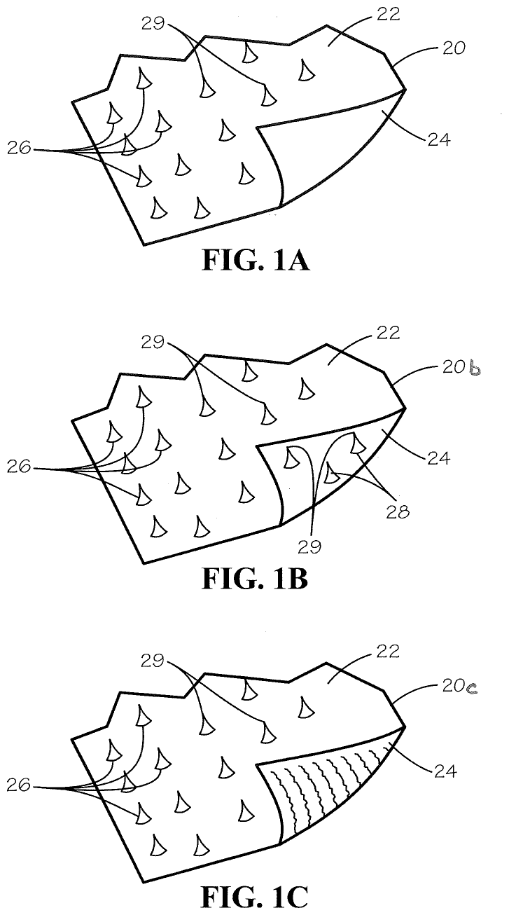

With reference to the drawings, in which like parts have like identifiers, FIG. 1A illustrates in perspective view a geomembrane 20 in accordance with the present invention. The geomembrane 20 is a polymeric extruded elongated sheet having opposing surfaces 22, 24 and generally having a length and width significantly greater than a thickness. A plurality of spaced-apart first projections or spikes 26 populate the geomembrane extending from the first surface 22. As discussed below, the projections 26 on the first surface mechanically engage respective geotextile sheets that are adjacent aggregation fill materials above (or below) the respective geotextile sheet, whereby the aggregation of fill materials has increased resistance to shear forces. For example, the geomembrane 20 may install as an impermeable liner for a landfill, an overlay component of a landfill site closure system, a stabilizing foundational layer in a roadway subsurface, or a stabilizing layer in a backfill of a retaining wall structure.

FIG. 1B illustrates in perspective view a second embodiment of a geomembrane 20b in accordance with the present invention. The geomembrane 20b differs from the geomembrane 20 with a plurality of spaced-apart second projections 28 extending from the second opposing surface 24. The projections 26, 28 may be tapered spikes each with a distal pointed apex 29, such as extending tips, spines, pins, knobs, posts, extending members, projections with distal pointed tips, angled tipped members, or other shaped extending members that may engage, puncture, or pierce a portion of the fill materials, a geotextile sheet, soil, waste, or fill material at a land site. The projections 26 may be different from the projections 28.

FIG. 1C illustrates in perspective view a third embodiment of a geomembrane 20c in accordance with the present invention. The geomembrane 20c differs from the geomembrane 20 with a texturing of the second opposing surface 24. Thus, the geomembrane 20C uses the projections 26 extending from the first side while the opposing second side may be textured, or alternatively, smooth, without projections extending from the second side.

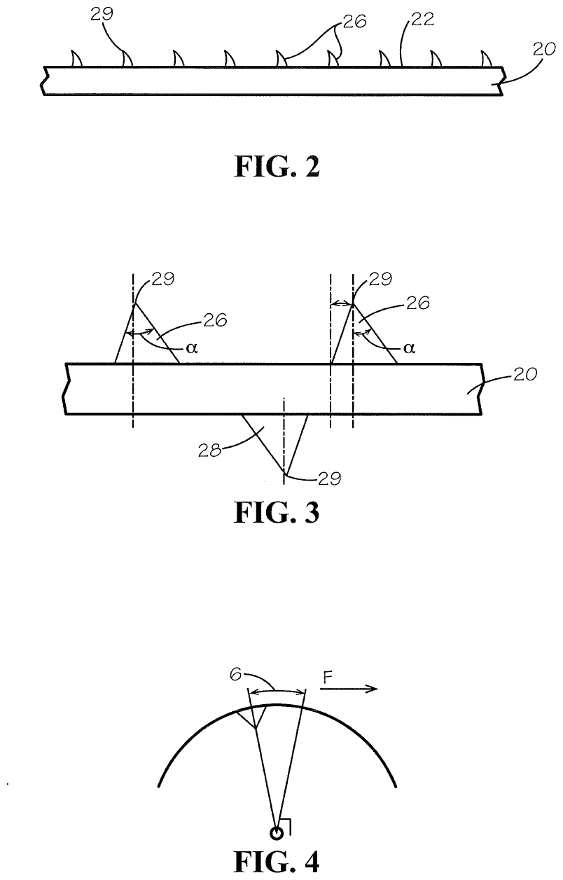

With reference to FIG. 2, the projections 26 in the illustrated embodiment are conical elongated members or spikes that each taper conically from the surface 22 to an apex 29. The apex 29 preferably defines a pointed tip for piercingly engaging a surface, such as a back surface of a geotextile sheet as discussed below. FIG. 2 is exaggerated in scale for illustration purposes because the projections 26 extend from about 10 mills to about 150 mills, and preferably about 40-120 mills, and more preferably about 100 mills. The spikes 26 define relatively small extending textured presence on the surface of the geomembrane. The base of the spike 26 has a diameter of about 25 mills to about 100 mills, preferably about 40 mills to about 85 mills, more preferably about 60 mills. The projections 28 illustrated in alternate embodiment in FIG. 1b are similar conical elongated members or spikes extending from the bottom surface 24. The spacing (or density of distribution) of the first projections 26 may selectively be the same as or different than the spacing (or density of distribution) of the second projections 28. The spacing of the projections 26, 28 may range from about 1 projection per square foot to about 60 projections per square foot, more preferably from about 25 projections per square foot to about 50 projections per square foot, and more preferably about 36 projections per square foot (providing in such embodiment a 2 inch spacing (machine direction and cross direction) of adjacent projections 26, 28). However, a preferred embodiment may have as few as one to five spikes per square foot. The particular spacing (and thus the number of projections per square inch) is derived by considering the interface resistance required between the geomembrane 20 and material to be mechanically engaged, such as a geotextile or synthetic grass or turf sheet discussed below to maintain the tufted geotextile free from slippage relative to the geomembrane and especially during high hydraulic sheer forces from water flow during precipitation and water flooding conditions, and particularly proximate lower portions of steep slopes of covered land surfaces. Generally, fewer, but taller projections 26, 28 are preferred for extending into and mechanically engaging, piercing, or penetrating a synthetic drainage layer such as in a ground covering embodiment that includes an overlay of a synthetic grass or tufted geosynthetic.

The geomembrane 20 is preferably made of very low density polyethylene, linear low density polyethylene (LLDPE), high density polyethylene (HDPE), or polyvinyl chloride.

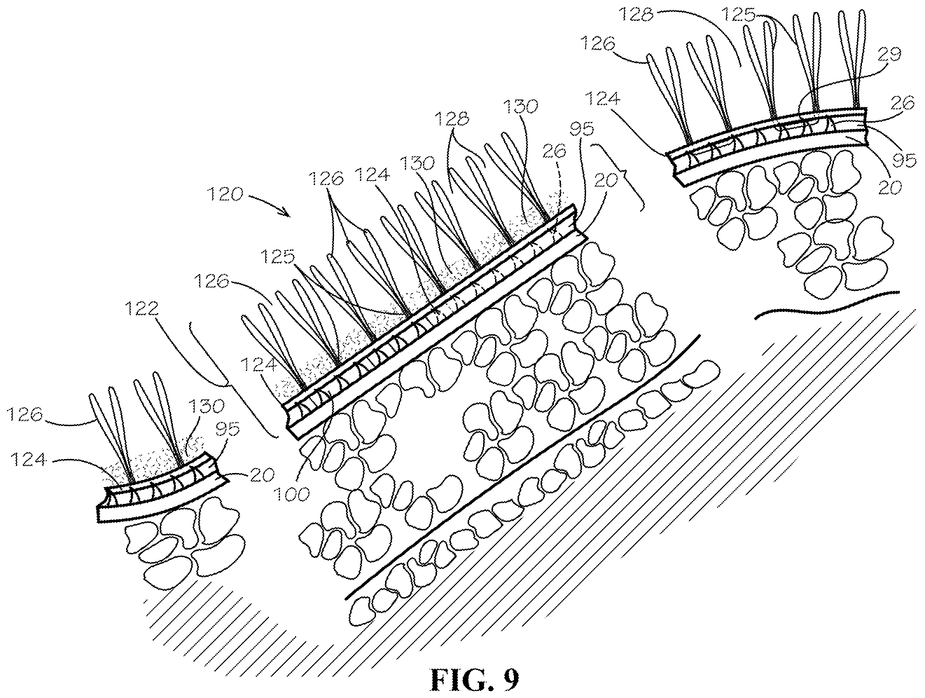

The illustrated embodiments provide an interface resistance to slippage of aggregations of particulate and solids materials such as slippage occurring between layers of the aggregation or slippage of sloped surfaces. In a covering application discussed below in FIG. 9, the plurality of first projections 26 engage grippingly a synthetic drainage layer overlaid by a tufted geotextile sheet (such as a lightweight geocomposite drainage and synthetic turf) and restrict lateral movement of the fill materials relative to the geomembrane 20. In the embodiment of FIG. 1B, the plurality of second projections 28 further engage grippingly a surface (such as a ground surface or fill material). In the illustrated embodiment, a density of 1 to 36 projections 26 per square foot provides mechanical engagement interface resistance sufficient to hold the overlaid tufted geotextile from movement and allow frictional forces to restrict lateral movement of the fill material relative to the geomembrane 20 especially on steep slopes. Alternate embodiments may have a lower, or greater, density of projections 26, for example, as low as one (1) projection per square foot. The present invention provides the projections 26 that mechanically engage for securing the covering, such as the tufted geosynthetic from movement and cooperatively allow the mass of the covering to develop resisting frictional forces to the shear forces that cause movement and slope failure of the aggregation which otherwise such lightweight synthetic covers develop insufficient frictional engagements.

### Oriented Spiked Geomembrane

FIG. 3 illustrates in enlarged cross-sectional view the geomembrane 20 with the spaced-apart first projections or spikes 26 extending from the first surface 22. The projections 26 in the illustrated embodiment orient to have a tilt angle in opposition to a machine direction of the sheet. The extrusion process deforms the projections 26 before cooling of the extruded geomembrane 20. The tilt angle of the projections 26 forms during calendaring of the extruded sheet between opposing calendar rollers that define the spikes or projections that cooperatively develop shear resistance in use in a covering system. The process applies a pulling force on the extruded sheet slightly faster than the infeed rate of the sheet from the extruder die of the extrusion into a gap between a pair of opposing calendar rollers. This slightly deforms the projections 26 from a perpendicular axis to have a tilted axis of less than 90 degrees relative to a perpendicular to the surface 22. The tilted projection in the illustrative embodiment thereby has a leaning edge in the projection such that the projection functions as a tooth, for example, to grab a portion of a bottom surface of a geotextile sheet, or a portion of a synthetic drainage layer for mechanical high strength engagement between the geomembrane and the engaged layer (a geotextile sheet or synthetic geocomposite drainage layer or synthetic turf), and thus, provide stabilization of the fill material in a materials aggregation application. The second embodiment of the geomembrane 20b similarly forms the tilted projections 28 with respective tips 29.

As illustrated in FIG. 3, the projection 26 is a leaning spike having a cross-sectional oblique angle α, with a leaning edge angled relative to a perpendicular to the surface. The oriented spikes thereby have a tilt or angle α from perpendicular relative to the surface. As illustrated schematically in FIG. 4, the tilt angle α is between about 1 degree to about 45 degrees, preferably about 5 degrees to about 20 degrees, and more preferably about 10 degrees to about 15 degrees. The apex 29 thereby defines an angled pointed tip for engaging a fabric or geotextile. The plurality of spikes 26 cooperatively distributes the loading on the fabric or geotextile to resist slippage relative to the geomembrane 20.

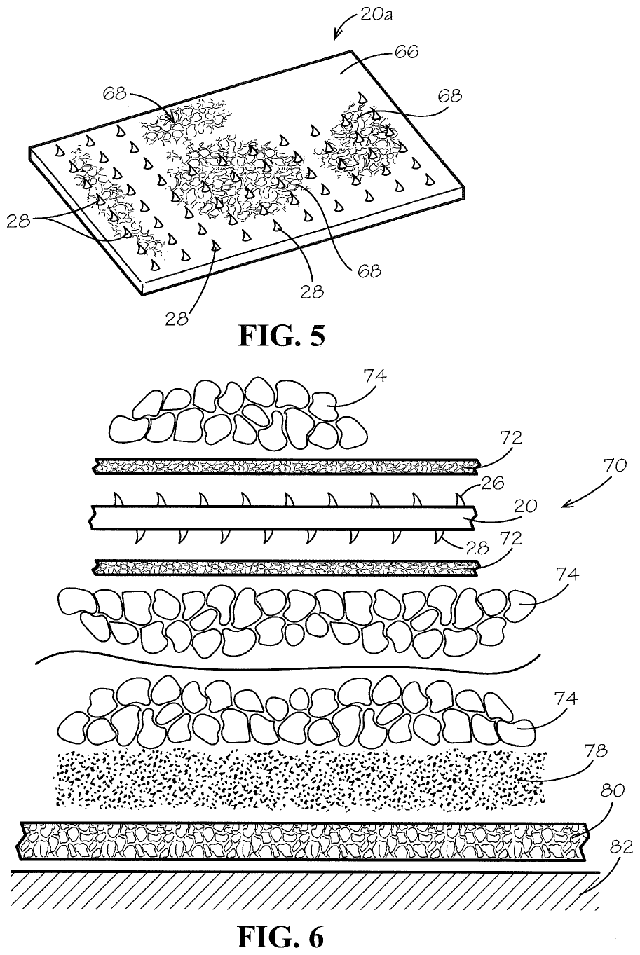

FIG. 5 illustrates an alternate embodiment of a geomembrane sheet 20a in which at least one surface 66 defines a texture generally 68, such as protruding ridges and recessed valleys among the projections 28. One or both surfaces 22, 24 may have the texture 68.

### Aggregation Applications

As noted above, the geomembrane 20 may be used for providing resistance to high shear forces that may arise in materials aggregation applications, such as in mounded or layered infill aggregation applications including landfill and waste site operations including as a site liner or as a component of a covering system for closure of a landfill. In such application involving sloped land for closing coverage, the geomembrane 20 is preferably oriented with the pointed apex 29 of the spikes 26 facing uphill in opposition to a force inducing slippage downwardly along sloped land but may be oriented facing downhill or transverse on sloped surfaces. In other applications, the geomembrane 20 may be installed as a stabilizing layer in a layered backfill for retaining walls or as a foundational layer in a roadway application. FIG. 6 illustrates in exploded detailed cross-sectional view a materials aggregation application 70 with one of the geomembranes 20 mechanically engaged to a fabric or geotextile sheet 72 for resisting shear forces and increase stabilization of the fill material 74 in the materials aggregation 70. Also, as illustrated, the geomembrane 20 may mechanically engage a lower geotextile sheet 76. A lower portion of the materials aggregation site may alternately include a transitory layer 78 such as a smaller particulate material and a liner 80 (preferably impermeable to water flow) overlying a ground surface 82.

The geotextile sheet 72 comprises a woven or non-woven textile. In the illustrated embodiment, the geotextile sheet 72 is non-woven but may be woven with warp and waft yarns. The geotextile sheet 72 has a weight basis or mass of between about 3 ounces per square yard to about 16 ounces per square yard, more preferably about 6 ounces per square yard to about 9 ounces per square yard, and preferably of about 6 to 8 ounces per square yard.

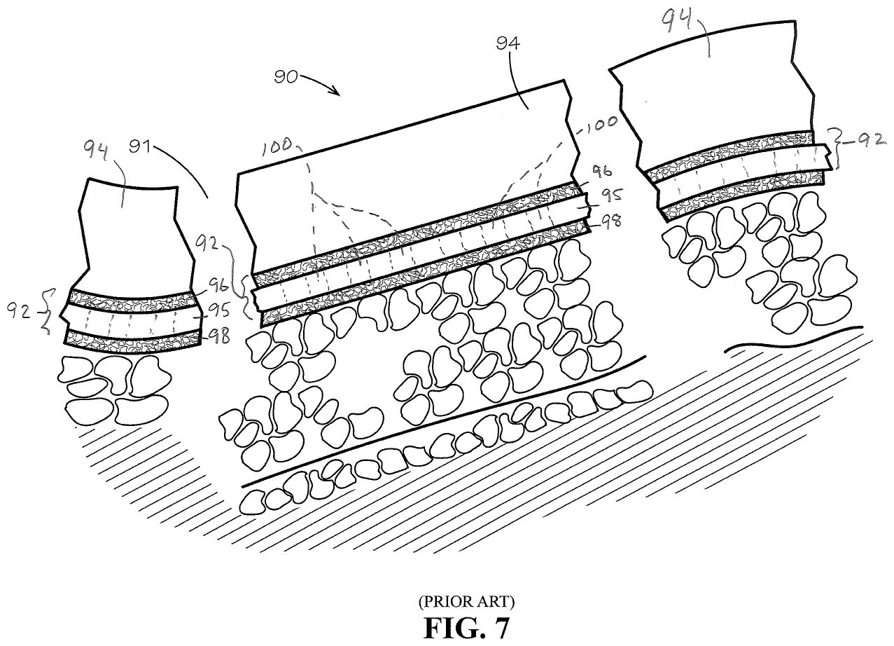

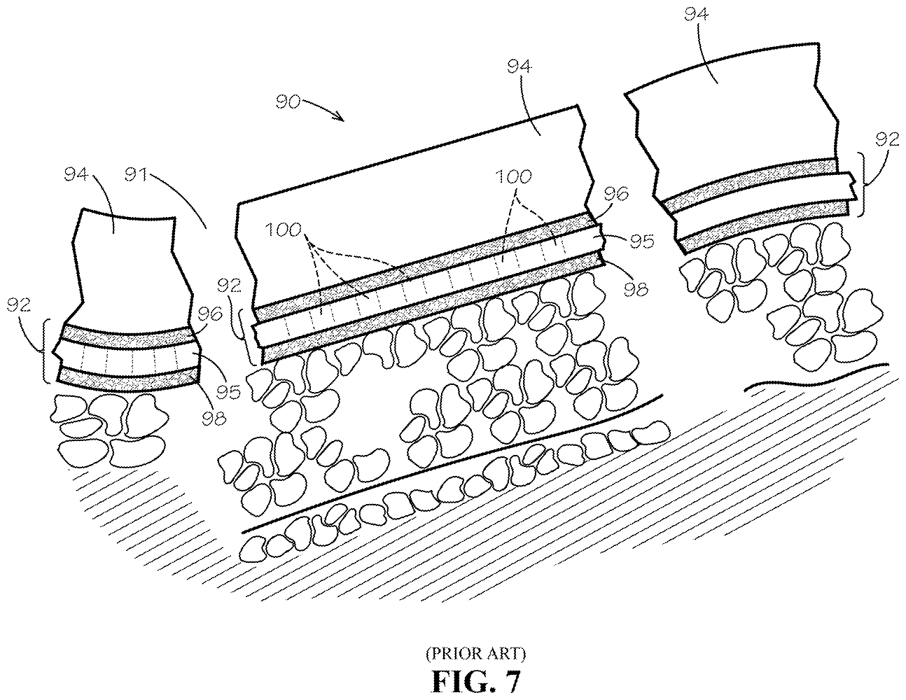

FIG. 7 illustrates in cross-sectional view a sloped portion of a surface of an aggregation application 90 such as a mounded waste material landfill on a land site covered with a prior art closure system generally 91. The landfill site is closed with the covering closure system 91 using a synthetic drainage assembly 92 overlaid by a mass material 94 for holding frictional engagement between the synthetic drainage assembly and the overlaid surface. FIG. 7A illustrates in perspective view a detailed portion of the synthetic drainage assembly 92 having a synthetic mesh grid 95 with an attached overlying permeable fabric layer 96 and an underlying nonpermeable layer 98. The synthetic mesh grid 95 defines a plurality of space-apart openings 100 therethrough. The mass material 94 typically comprises a layer of dirt, typically 18 inches to 24 inches, overlaid on the synthetic drainage assembly 92. The dirt as the mass material 94 develops friction between the synthetic drainage layer and the aggregation, which resists slope failure. The mass material 94 loads the synthetic drainage assembly 92 on the surface and seeks to resist sliding of the site covering system. Ambient or environmental water such as rail fall percolates through the dirt layer and along the mesh grid 94 to drainage. Despite the loading of the mass material 94, slippage nevertheless occurs.

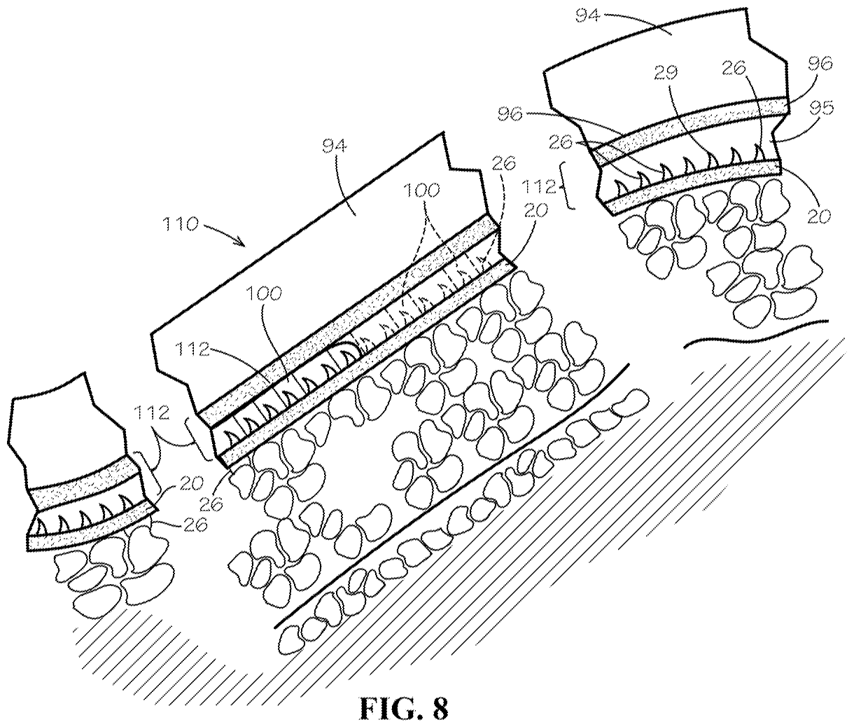

FIG. 8 illustrates in exploded cross-sectional view an aggregation application 110 using the geomembrane 20 in mechanical and frictional engagement with a land site covering system of a mass material 94 overlying a synthetic drainage system 112 for aggregation stabilization and resisting shear force failure, in accordance with the present invention. In this illustrated embodiment, the mass material 94 comprises a layer of soil or dirt but less volume than required in the site application illustrated in FIG. 6. The synthetic drainage system 112 comprises the synthetic mesh grid 95 and fabric layer 96 for preventing dirt from filing the openings 100 in the mesh grid. The apex defining spikes 20 (illustrated in cut-away detailed view) inter-engage mechanically with the synthetic drainage layer 95 and the covering soil 94 provides mass for frictional engagement of the geomembrane 20 to the surface of the aggregated materials placed in the landsite.

FIG. 9 illustrates in exploded cross-sectional view (partially cut-away) an aggregation application 120 using the geomembrane 20 in mechanical engagement with the mesh grid 95 as the synthetic drainage system overlaid by a synthetic grass or tufted geosynthetic 122 for aggregation stabilization and resisting shear force failure, in accordance with the present invention. The tufted geosynthetic 122 comprises a fabric backing 124 tufted with elongated yarns to define a plurality of spaced-apart tufts 125 of synthetic grass blades 126. The tufts 125 define interstices 128 therebetween. The spikes 26 of the geomembrane 20 mechanically engage grippingly the geomesh grid 95 overlaid by the tufted geosynthetic 122 as a covering system. Alternatively, as illustrated, the tufted geosynthetic 122 may be weighted with an overfill 130 of particulates, sand, combination sand and cement material, or the like. The overfill 130 shades the tufts 125 from UV degradation and provides a mass for further frictional contact between the geomembrane and the slip-prone covering of the aggregation of the land site.

The backing sheet 124 may be a woven or non-woven textile, and may comprise one or a plurality of separate sheets tufted together. The backing sheet 124 may have weight basis or mass of between about 6 ounces per square yard to about 24 ounces per square yard. The tufting yarns interweave through the backing to define spaced-apart rows of the tufts 125 that extend from the geosynthetic 20 as the grass-like blades 126. The tufts 125 tuft on spacing in a range from about ¼ inch to 1 inch, preferably ½ inch. The blades 126 extend from the backing sheet 124 about ½ inch to about 4 inches, and more preferably from about 1 inch to about 1 and ½ inches. The adjacent blades 126 define the interstices 128. The interstices 128 receive the distributed granular infill 130 selectively to a fill plane (preferably less than and no more than a greatest extent defined by about a distal extent of the blades 126). The backing sheet 124 forms of a polymer material that resists exposure to sunlight that generates heat rise in the geosynthetic 20 and that resists ultraviolet (UV) radiation in the sunlight, which degrades the backing sheet and the tufted blades. The polymer yarns further should not become brittle when subjected to low temperatures. The color selection of the yarns for the backing sheet 124 are preferably black and/or gray yarns. The color selection for the tufting yarns are green or brown, to simulate tufts 126 of grasses. The tufts may be tufted in combinations for closer simulation of the area to be covered, for example using a respective proportion of a first, second, or more, color yarns. Further, the polymeric material for the yarns that are woven to form the backing sheet or the polymers spun bond for a non-woven backing sheet, include UV resistant additives such as HALS and carbon black. The polymers are selected to provide high shear strength resistance for the geotextile 20. The backing sheet has strong tensile strength, in a range of about 1,000 pounds per foot to about 4,000 pounds per foot.

The cover system may gainfully use the granular infill 130 received within the interstices 128 between the tufts 125. The infill 130 is a granular material cooperating with the extending blades 126 of the tufts 24 to shadow the backing sheet 22 and further enhances the friction developed with the tufted geosynthetic covering. The infill 130 fills onto the backing sheet 124 and within the interstices 128 therefrom preferably to about a second extent that is generally less than the fill plane of the geosynthetic. The infill 130 cooperates with the blades 126 to shadow the backing sheet 124 from UV exposure and degradation. The infill 38 may be a sand material, and further particularly may comprise a fire retardant additive or product independent of a sand carrier mixture, such as a non-halogenated magnesium hydroxide powder, silicates including potassium silicate, calcium silicate, and sodium silicate, or other in situ fire suppression or resistant material.

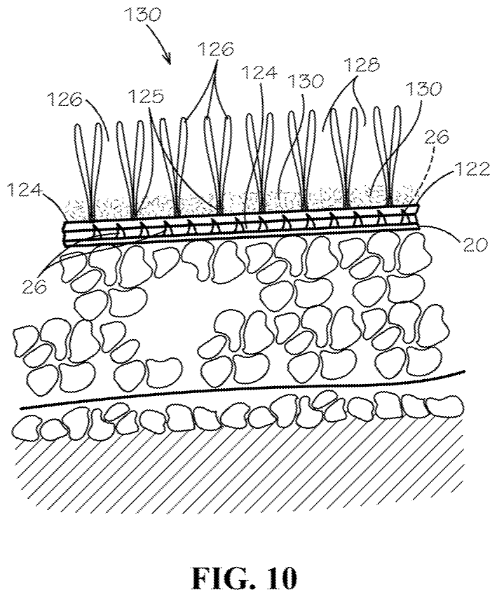

FIG. 10 illustrates an alternate embodiment 130 for level, or substantially level aggregation or ground surfaces. The spikes 26 of the geomembrane 20 make mechanical, piercing engagement with the backing 124 of the synthetic grass tufted geosynthetic 122 for aggregation stabilization and resisting shear force failure, in accordance with the present invention. As illustrated, the tufted geosynthetic 122 may alternatively include the additional mass of the particulate infill 130 that further provides UV shading for reduced degradation of the tufted geosynthetic 122 and enhances development of friction of the lightweight tufted geosynthetic grass 122. The spikes 26 of the geomembrane 20 mechanically engage grippingly the backing 124 of the overlaid tufted geosynthetic 122 as a covering system. The mechanical engagement resists movement of the geosynthetic under shear loading whereby the mass develops frictional engagement to resist aggregation slippage or movement. With a level or slightly sloped surface, the ambient water passes through the infill and the backing 124 to travel on the upper surface of the geomembrane in interstices between the upper surface and the geomembrane. The spikes 26 retain the tufted geosynthetic 122 in covering relation and while thereby stabilized from movement the tufted geosynthetic develops frictional engagement for resisting shear forces. In an alternate application for level or slightly sloped surfaces, the infill 130 further shades the tufted geosynthetic 122 from UV degradation but also enhance the frictional engagement that is cooperatively enhanced by the spikes 26 to resist shear loading.

The foregoing discloses an improved geomembrane for use in resisting shear loading in materials aggregation applications and in reducing stabilization failures of materials aggregation applications, comprising an elongated polymeric impermeable sheet having opposing surfaces with a plurality of spaced-apart first projections extending from a first surface, which projections for mechanically engaging a synthetic drainage overlaid by a respective geotextile sheet and in contact with adjacent fill materials within the aggregation, whereby the aggregation has increased resistance to shear failure of the aggregation of fill materials. While the invention has been described with particular reference to various embodiments, variations and modifications can be made without departing from the spirit and scope of the invention recited in the appended claims.

1. A geomembrane for use in resisting shear loading in materials aggregation applications and in reducing stabilization failures of materials aggregation applications, comprising:
an elongated polymeric impermeable sheet having opposing first and second surfaces;
a plurality of spaced-apart first projections extending from the first surface;
the first projections tapering to a pointed apex at a distal extent and the first projections tilted at an oblique angle relative to a perpendicular from the apex to the first surface, which first projections for mechanically engaging a respective geotextile sheet in contact with adjacent fill materials within the aggregation;
whereby the aggregation has increased resistant to shear failure of the aggregation of fill materials.

2. The geomembrane as recited in claim 1, wherein the oblique angle is from about 1 degree to about 45 degrees.

3. The geomembrane as recited in claim 1, wherein the oblique angle is from about 5 degrees to about 20 degrees.

4. The geomembrane as recited in claim 1, wherein the oblique angle is from about 10 degrees to about 15 degrees.

5. The geomembrane as recited in claim 1, further comprising a plurality of spaced-apart second projections extending from the opposing second surface.

6. The geomembrane as recited in claim 5, wherein the first projections are spaced apart to have a first density and the second projections are spaced apart to have a second density.

7. The geomembrane as recited in claim 5, wherein the extent of the first projections is a first length and the extent of the second projections is a second length, the first length different from the second length.

8. The geomembrane as recited in claim 1, wherein the first projections extend from the respective surface an extent from about 10 mills to about 100 mills.

9. The geomembrane as recited in claim 1, wherein the first projections extend from the first surface about 40 mils.

10. The geomembrane as recited in claim 1, wherein the plurality of first projections provides an interface shear strength to resist a shear load.

11. A ground cover system for a covering closure of a land site, comprising:
an elongated polymeric impermeable sheet having opposing first and second surfaces, for overlying a ground surface to be closed;
a plurality of spaced-apart first projections extending from the first surface, each said first projections tapering to a respective pointed apex at a distal extent; and
a covering for overlying the first surface of the elongated polymeric impermeable sheet,
which first projections for mechanically engaging the covering,
whereby the aggregation has increased resistance to shear failure of the aggregation of fill materials for reducing stabilization failures of materials in aggregation land sites.

12. The ground cover system as recited in claim 11, wherein the covering comprises a mechanical drainage assembly and a layer of a dirt material for overlying the mechanical drainage assembly.

13. The ground cover system as recited in claim 12, wherein the mechanical drainage assembly comprises a mesh sheet overlaid by a non-woven layer, whereby the first projections for mechanically engaging the mesh sheet.

14. The ground cover system as recited in claim 11, wherein the covering comprises:
a synthetic drainage layer for overlying an aggregation of a land site; and
a geotextile comprising a woven backing tufted with a plurality of yarns defining a plurality of spaced-apart tufts of simulated grass blades extending from the backing, which upon said geotextile being overlaid on the first surface, the first projections being mechanically engaged to a back surface of the woven backing resists geotextile movement under shear loading for frictional stabilization of the overlaid aggregation.

15. The ground cover system as recited in claim 14, further comprising an infill for being received on an upper surface of the backing sheet within interstices defined by the spaced-apart tufts.

16. The ground cover system as recited in claim 11, wherein the covering comprises a geotextile comprising a woven backing tufted with a plurality of yarns defining a plurality of spaced-apart tufts of simulated grass blades extending from the backing, which upon said geotextile being overlaid on the first surface, the first projections being mechanically engaged to a back surface of the woven backing.

17. The ground cover system as recited in claim 11, wherein the oblique angle is from about 1 degree to about 45 degrees.

18. The ground cover system as recited in claim 11, wherein the oblique angle is from about 5 degrees to about 20 degrees.

19. The ground cover system as recited in claim 11, wherein the oblique angle is from about 10 degrees to about 15 degrees.

20. The ground cover system as recited in claim 11, wherein the first projections extend from the respective surface an extent from about 10 mills to about 100 mills.

21. The ground cover system as recited in claim 11, wherein the first projections extend from the first surface about 40 mils.

22. The geomembrane as recited in claim 11, further comprising a plurality of spaced-apart second projections extending from the opposing second surface.

23. An aggregation cover system for a covering closure, comprising:
a liner sheet having opposing first and second surfaces, for overlying an aggregation surface to be closed;
a plurality of spaced-apart spikes extending from the first surface, each said first projections tapering to a respective pointed apex at a distal extent; and
a tufted geosynthetic of a backing sheet tufted with yarns to define a plurality of spaced-apart tufts of synthetic grass blades extending from the backing sheet as a covering for overlying the first surface of the liner sheet, whereby said spikes for mechanically engaging the backing sheet to resist movement of the tufted geosynthetic during shear loading while the tufted geosynthetic frictionally engages the aggregation surface,
whereby the aggregation has increased resistance to shear failure of the aggregation of fill materials for reducing stabilization failures of materials in aggregation land sites.
